(19) United States
(12) Patent Application Publication
(10) Pub. No.: US 2023/0136713 A1
(43) Pub. Date: May 4, 2023

(54) SENSING DEVICE, SENSING SYSTEM, SENSING METHOD, AND STORAGE MEDIUM

(71) Applicant: TOYOTA JIDOSHA KABUSHIKI KAISHA, Toyota-shi Aichi-ken (JP)

(72) Inventors: Yosuke KIMURA, Nisshin-shi Aichi-ken (JP); Yasuhiro UEHARA, Nagoya-shi Aichi-ken (JP)

(73) Assignee: TOYOTA JIDOSHA KABUSHIKI KAISHA, Toyota-shi Aichi-ken (JP)

(21) Appl. No.: 17/950,750

(22) Filed: Sep. 22, 2022

(30) Foreign Application Priority Data
Oct. 29, 2021 (JP) 2021-178149

(51) Int. Cl. G07C 5/08; G07C 5/02; G07C 5/00; G01L 17/00

(52) U.S. Cl. CPC G07C 5/0816; G01L 17/00; G07C 5/02; G07C 5/008

(57) ABSTRACT

A server as a sensing device is configured such that a calculation unit handles pieces of sampled vehicle data divided and assigned to data ranges set in advance, and calculates linear interpolation by using coordinate information on the vehicle data representing at least one of a longitudinal acceleration, a steering angle, and a lateral acceleration with respect to a relative difference in wheel speed between predetermined ones of front and rear wheels or right and left wheels of a vehicle, for the data ranges, that the calculation unit registers the vehicle data corresponding to a Y-intercept as to the relative difference in wheel speed between the predetermined wheels, based on the calculated linear interpolation, for the data ranges, and that a sensing unit senses air pressure decrease in a tire by using the difference in wheel speed between the predetermined wheels in the registered vehicle data, for the data ranges.

### CROSS-REFERENCE TO RELATED APPLICATION

This application claims priority to Japanese Patent Application No. 2021-178149 filed on Oct. 29, 2021, incorporated herein by reference in its entirety.

### BACKGROUND

### 1. Technical Field

The present disclosure relates to a sensing device, a sensing system, a sensing method, and a storage medium that perform control regarding the sensing of an air pressure in a tire of a vehicle.

### 2. Description of Related Art

In Japanese Unexamined Patent Application Publication No. 2006-015894 (JP 2006-015894 A), there is disclosed an art regarding a tire air pressure warning system that can prevent the occurrence of a phenomenon in which a receiver side erroneously recognizes that a system is not in normal operation after activation of a transmitter in a stopped state and then a warning is issued. Tire air pressure sensors provided in this art are attached to a plurality of tires respectively, and have transmitters that transmit data including measured tire air pressures at intervals of a predetermined time respectively.

### SUMMARY

A direct method in which the internal pressure of a tire is measured, and an indirect method in which a difference in wheel speed is used are available to sense an air pressure in the tire. The art described in JP 2006-015894 A corresponds to the direct method. However, the direct method requires the pressure sensors and an ECU to be assembled with a vehicle, and hence leads to costly development. The indirect method makes the pressure sensors unnecessary, and requires the development of an ECU for adaptation to individual vehicle type conditions. Besides, the indirect method also requires conditions on load and the like to be set, so there is room for improvement in the enhancement of accuracy.

It is an object of the present disclosure to provide a sensing device, a sensing system, a sensing method, and a storage medium that can sense a fall in air pressure in a tire in various running scenes.

A sensing device set forth in a first aspect is equipped with a processor. The processor handles a plurality of pieces of sampled vehicle data divided and assigned to a plurality of data ranges set in advance respectively, and calculates linear interpolation through the use of coordinate information on the pieces of vehicle data representing at least one of a longitudinal acceleration, a steering angle, and a lateral acceleration with respect to a relative difference in wheel speed between predetermined wheels, that is, front and rear wheels or right and left wheels of a vehicle, for the data ranges respectively. The processor registers the pieces of vehicle data corresponding to a Y-intercept as to the relative difference in wheel speed between the predetermined wheels, based on the calculated linear interpolation, for the data ranges respectively. The processor senses a fall in air pressure in a tire through the use of the difference in wheel speed between the predetermined wheels in the registered pieces of vehicle data, for the data ranges respectively.

The sensing device set forth in the first aspect registers the pieces of vehicle data corresponding to the Y-intercept based on the predetermined linear interpolation, and senses a fall in air pressure in the tire through the use of the difference in wheel speed between the predetermined wheels in the registered pieces of vehicle data. By thus using the linear interpolation, the fall in air pressure in the tire can be sensed from the pieces of vehicle data acquired in various running scenes as well as the pieces of vehicle data during steady running. Besides, a device for sensing a fall in air pressure can be realized at low cost, without incurring the costs of additional development of an ECU and the like.

A sensing device set forth in a second aspect is obtained by modifying the sensing device set forth in the first aspect as follows. That is, a first value is defined as the registered piece of vehicle data. The processor compares the difference in wheel speed between the predetermined wheels corresponding to the first value with the difference in wheel speed between the predetermined wheels corresponding to a second value registered as the first value prior to the first value, and determines whether or not the difference in wheel speed about only a specific one of the wheels has been resolved with a value equal to or larger than a threshold, from a relationship between values obtained by subtracting the difference in wheel speed corresponding to the first value from the difference in wheel speed corresponding to the second value, in the sensing. The processor determines that the fall in air pressure has been resolved when it is determined that the difference in wheel speed has become equal to or larger than the threshold. The processor determines that there is a possibility of a fall in air pressure, and senses the fall in air pressure through use of the wheel speeds of the respective wheels in the piece of vehicle data corresponding to the first value, when it is determined that the difference in wheel speed has not become equal to or larger than the threshold.

According to the sensing device set forth in the second aspect, the determination is made by comparing the differences in wheel speed between the predetermined wheels with each other. This determination makes it possible to determine that the fall in air pressure has been resolved, and if necessary, to sense the fall in air pressure.

A sensing device set forth in a third aspect is obtained by modifying the sensing device set forth in the first aspect as follows. That is, the processor adopts the most recent first value as an initial value, and deletes a history of the first value registered previously, when it is determined that the difference in wheel speed has become equal to or larger than the threshold and it is sensed that the fall in air pressure has been resolved.

According to the sensing device set forth in the third aspect, it is possible to update the initial value and retain the data required for sensing.

A sensing device set forth in a fourth aspect is obtained by modifying the sensing device set forth in the second or third aspect as follows. That is, the processor determines that the air pressure has fallen as to the specific one of the wheels, at least either when there is a difference in wheel speed that is equal to or larger than the threshold between certain ones of the wheels and only the wheel speed of the specific one of the wheels is high as a result of a comparison between the difference in wheel speed between the predetermined wheels corresponding to the first value and the difference in wheel speed between the predetermined wheels corresponding to the initial value registered in advance, or when there is a difference in wheel speed that is equal to or larger than the threshold between certain ones of the wheels and only the wheel speed of the specific one of the wheels is high as a result of a comparison between the differences in wheel speed between the predetermined wheels corresponding to the first value, in sensing the fall in air pressure in a case where there is a possibility of the fall in air pressure.

According to the sensing device set forth in the fourth aspect, it is possible to sense the fall in air pressure when only the wheel speed of the specific one of the wheels is high, through the use of the registered vehicle data.

A sensing device set forth in a fifth aspect is obtained by modifying the sensing device set forth in any one of the first through fourth aspects as follows. That is, each of the data ranges is a range set as to a combination of a vehicle speed zone of the vehicle and a certain time unit. The processor calculates the linear interpolation through the use of the pieces of vehicle data divided and assigned to the data ranges respectively, registers the pieces of vehicle data, and senses the fall in air pressure, for the data ranges respectively.

According to the sensing device set forth in the fifth aspect, it is possible to set the vehicle speed zone and the certain time unit in each of the data ranges, and realize the accurate sensing of the fall in air pressure.

A sensing device set forth in a sixth aspect is obtained by modifying the sensing device set forth in any one of the first through fifth aspects as follows. That is, the predetermined wheels include the front-right wheel and the rear-right wheel as first wheels and the front-left wheel and the rear-left wheel as second wheels, as to the front and rear wheels, and the front-right wheel and the front-left wheel as third wheels and the rear-right wheel and the rear-left wheel as fourth wheels as to the right and left wheels. The processor calculates linear interpolation through the use of coordinate information on the pieces of vehicle data representing the longitudinal acceleration with respect to a relative difference in wheel speed between the first wheels and a relative difference in wheel speed between the second wheels, and calculates linear interpolation through the use of coordinate information on the pieces of vehicle data representing the steering angle or the lateral acceleration with respect to a relative difference in wheel speed between the third wheels and a relative difference in wheel speed between the fourth wheels, for the data ranges respectively. The processor registers the pieces of vehicle data on the Y-intercept as to the relative differences between the first wheels, the second wheels, the third wheels, and the fourth wheels respectively, for the data ranges respectively. The processor senses a fall in air pressure in a tire of a specific one of the wheels from a relationship between changes in the differences in wheel speed in the pieces of vehicle data registered as to the first wheels, the second wheels, the third wheels, and the fourth wheels, for the data ranges respectively.

According to the sensing device set forth in the sixth aspect, it is possible to register the pieces of vehicle data on the Y-intercept as to the relative differences in wheel speed between the front and rear wheels as the predetermined wheels and the relative differences in wheel speed between the right and left wheels as the predetermined wheels, and sense a fall in air pressure in a specific one of the wheels from the relationship between changes in the registered differences in wheel speed.

A sensing device set forth in a seventh aspect is obtained by modifying the sensing device set forth in any one of the first through the sixth aspects as follows. That is, the processor registers a value of a gradient of the linear interpolation, and senses falls in air pressure in all the wheels of the vehicle by comparing the registered value with a value of a gradient preceding the registered value.

According to the sensing device set forth in the seventh aspect, the method of the disclosure is also applicable to the sensing in the case where the air pressures in all the wheels have fallen.

A sensing system set forth in an eighth aspect is equipped with the sensing device set forth in any one of the first through seventh aspects as a server. The sensing system acquires the pieces of vehicle data in the vehicle, and transmits the acquired pieces of vehicle data to the server. The server notifies the vehicle of a warning, upon sensing a fall in air pressure in a tire of a specific one of the wheels.

According to the sensing system set forth in the eighth aspect, it is possible to configure the sensing device as the server. By realizing the sensing device as the server, it becomes possible to realize the sensing of a fall in air pressure in the tire corresponding to various running scenes without advancing the development for assembling the device with the vehicle side.

A sensing method set forth in a ninth aspect causes a computer to perform a process in which a processor handles a plurality of pieces of sampled vehicle data divided and assigned to a plurality of data ranges set in advance respectively, and calculates linear interpolation through the use of coordinate information on the pieces of vehicle data representing at least one of a longitudinal acceleration, a steering angle, and a lateral acceleration with respect to a relative difference in wheel speed between predetermined ones of front and rear wheels or right and left wheels of a vehicle, for the data ranges respectively, the processor registers the pieces of vehicle data corresponding to a Y-intercept as to the relative difference in wheel speed between the predetermined wheels, based on the calculated linear interpolation, for the data ranges respectively, and the processor senses a fall in air pressure in a tire through the use of the difference in wheel speed between the predetermined wheels in the registered pieces of vehicle data, for data ranges respectively.

A sensing program set forth in a tenth aspect causes a computer to perform a process in which a processor handles a plurality of pieces of sampled vehicle data divided and assigned to a plurality of data ranges set in advance respectively, and calculates linear interpolation through the use of coordinate information on the pieces of the vehicle data representing at least one of a longitudinal acceleration, a steering angle, and a lateral acceleration with respect to a relative difference in wheel speed between predetermined ones of front and rear wheels or right and left wheels of a vehicle, for the data ranges respectively, the processor registers the pieces of vehicle data corresponding to a Y-intercept as to the relative difference in wheel speed between the predetermined wheels, based on the calculated linear interpolation, for the data ranges respectively, and the processor senses a fall in air pressure in a tire through the use of the difference in wheel speed between the predetermined wheels in the registered pieces of vehicle data, for the data ranges respectively.

According to the art of the present disclosure, it is possible to sense a fall in air pressure in a tire in various running scenes.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic view for illustrating a method for sensing a fall in air pressure in a tire from wheel speeds;

FIG. 1B is a schematic view for illustrating a method for sensing a fall in air pressure in a tire from wheel speeds;

FIG. 1C is a schematic view for illustrating a method for sensing a fall in air pressure in a tire from wheel speeds;

FIG. 2A is a graph showing that the differences in wheel speed change in accordance with load and vehicle speed;

FIG. 2B is a graph showing that the differences in wheel speed change in accordance with load and vehicle speed;

FIG. 3 is a view showing the schematic configuration of a sensing system according to one of the embodiments;

FIG. 4 is a block diagram showing the hardware configuration of a vehicle of the embodiment;

FIG. 5 is a block diagram showing the hardware configuration of a sensing device of the embodiment;

FIG. 6 is a block diagram showing the functional configuration of the sensing device of the embodiment;

FIG. 7A is a view showing an example of a graph on which pieces of vehicle data representing longitudinal acceleration are plotted;

FIG. 7B is a view showing an example of a graph on which pieces of vehicle data representing steering angle are plotted;

FIG. 8 is a flowchart showing the flow of a sensing process that is performed in the sensing device of the embodiment;

FIG. 9 is a flowchart showing the flow of a check process that is performed as an internal process of the sensing process;

FIG. 10 is a view showing the gradient of a line for linear interpolation; and

FIG. 11 is a flowchart showing the flow of a sensing process for four wheels that is performed in a sensing device of a modification example.

### DETAILED DESCRIPTION OF EMBODIMENTS

A sensing system of one of the embodiments of the disclosure will be described. The sensing system is a system that acquires pieces of vehicle data from a vehicle, and that senses a fall in air pressure in a tire of the vehicle with the aid of a server.

First of all, an indirect method of sensing a fall in air pressure through the use of wheel speeds on which the art of the present embodiment is premised will be described.

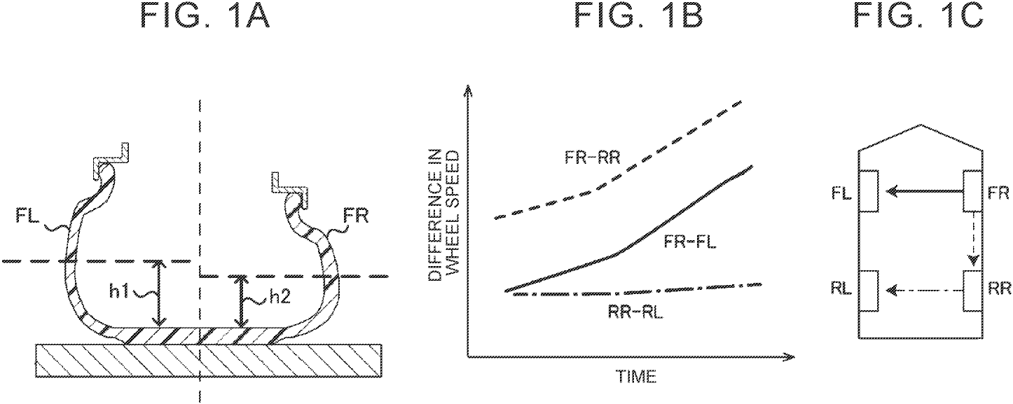

FIGS. 1A, 1B, and 1C are schematic views for illustrating a fall in air pressure in a tire from wheel speeds. In the example of FIGS. 1A, 1B, and 1C, the air pressure in the tire of a front-right wheel FR has fallen. FIG. 1A shows a front-left wheel FL and the front-right wheel FR, and indicates a situation where the air pressure in the tire of the front-right wheel FR has fallen. In this case, a radius of rotation h2 of the tire of the front-right wheel FR has become smaller than a radius of rotation h1 of the tire of the front-left wheel FL. When the radius of rotation of the tire of one of the wheels or each of some of the wheels decreases in this manner, there is created a difference in wheel speed. When the radius of rotation of the tire decreases, the wheel speed increases in an attempt to become equal to the wheel speed of the other wheels. In the indirect method, a fall in air pressure in the tire is sensed through the use of such a difference in wheel speed. FIG. 1B is a graph representing how the differences in wheel speed between the wheels change respectively. FIG. 1C shows how the wheels in the graph are related to one another. In the graph shown in FIG. 1B, the differences in wheel speed [FR-RR] and [FR-FL] increase with time, whereas the difference in wheel speed [RR-RL] does not change that much. As for [FR-RR] and [FR-FL], a difference in wheel speed equal to or larger than a certain value is sensed with the passage of time. In this manner, a fall in air pressure in the tire of the front-right wheel FR can be sensed from a relationship between changes in the differences in wheel speed between the wheels. Incidentally, a change in wheel speed of FR can also be identified only from a relationship between changes in the differences [FR-RR] and [RR-RL] in wheel speed between the wheels. That is, a change in wheel speed of a specific one of the wheels can also be identified only from a relationship between the front and rear wheels. By the same token, a change in wheel speed of a specific one of the wheels can also be identified only from a relationship between the right and left wheels.

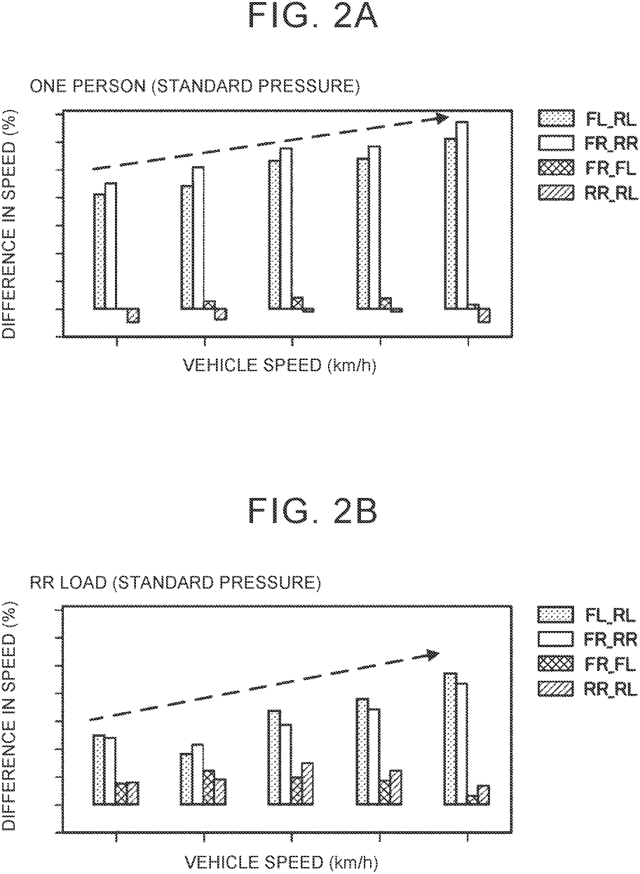

Besides, the indirect sensing needs to take the state of load into account as well. FIGS. 2A and 2B are graphs showing that the differences in wheel speed change in accordance with load or vehicle speed respectively. FIG. 2A shows the differences in wheel speed at each vehicle speed in the case where a standard pressure load corresponding to one person is applied to each of the wheels. FIG. 2B shows the differences in wheel speed at each vehicle speed in the case where the load is applied to the rear-right wheel RR. As shown in FIGS. 2A and 2B, the gradient of changes increases more in FIG. 2B than in FIG. 2A, as the vehicle speed rises. In this manner, the flexure of the tire caused by a load resulting from changes in the loading state and the state of the vehicle influences the wheel speed. Besides, the influences of vehicle speed and road surface input are not negligible either. With the foregoing taken into account, the differences in wheel speed change in accordance with the load, the vehicle speed, and the like, so it is desirable to be able to cope with such changes as well.

It is also possible to extract only pieces of vehicle data in a running scene where the behavior of the vehicle is stable, for example, a running scene where the vehicle steadily runs straight without being accelerated or decelerated from the entire running of the vehicle, and confirm differences in wheel speed. However, as shown in FIGS. 2A and 2B, the way the difference in wheel speed is created differs depending on the load and the state of the vehicle as well, so it is desirable to be able to cope with various running scenes. Besides, when an attempt is made to sense a fall in air pressure of the tire through the use of only the pieces of vehicle data in a steady state, the number of timings that enable sensing may become small, and also, the timing of issuing a warning may be delayed.

It has been revealed that a difference in wheel speed between the front and rear wheels is created through acceleration or deceleration, and that a difference in wheel speed between the right and left wheels is created through steering. Thus, in the present embodiment, the pieces of vehicle data in a stable state are obtained by making comparisons between longitudinal accelerations, steering angles or the like corresponding to relative differences between the differences in wheel speed between the wheels with each other, and a fall in air pressure is sensed from the differences in wheel speed. In the present embodiment, there is provided a sensing system that can sense a fall in air pressure in a tire in various running scenes including steady running according to this method.

### Overall Configuration

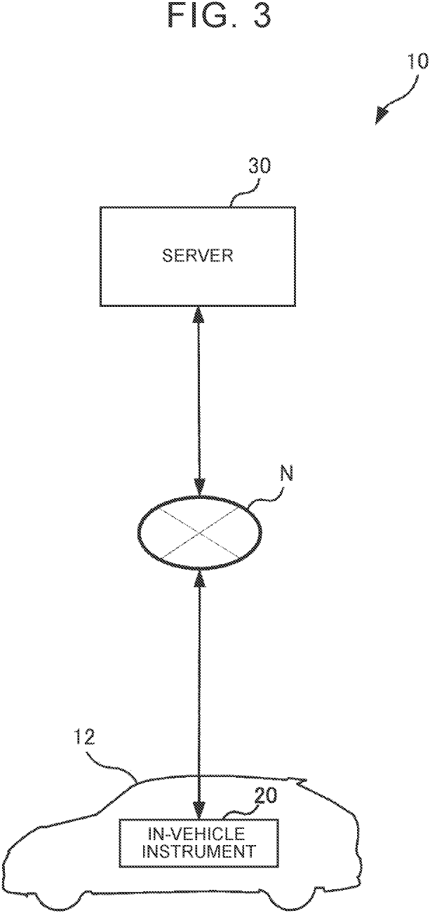

As shown in FIG. 3, a sensing system 10 of the embodiment of the disclosure is configured to include a vehicle 12 and a server 30 as a sensing device. Besides, the vehicle 12 is mounted with an in-vehicle instrument 20. The in-vehicle instrument 20 and the server 30 are connected to each other through a network N. Incidentally, although the single vehicle 12 and the single in-vehicle instrument 20 are depicted for the single server 30 in FIG. 3, the number of vehicles 12 and the number of in-vehicle instruments 20 are not limited thereto.

The server 30 is installed at, for example, a manufacturing company for manufacturing the vehicle 12, a car dealer’s store affiliated with the manufacturing company, a company providing a remote monitoring service, or the like.

### Vehicle

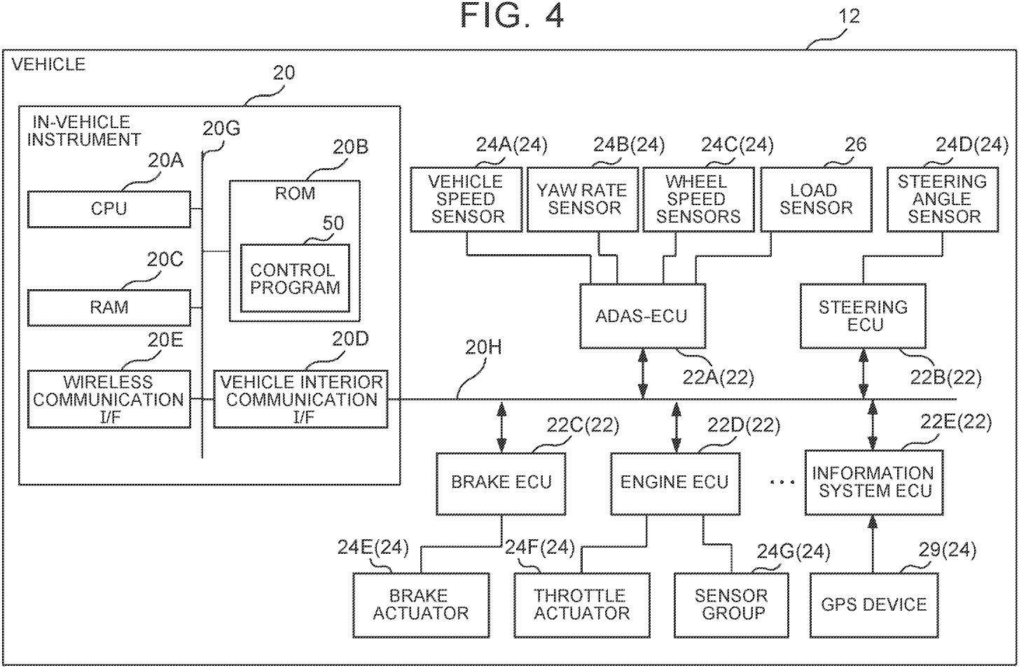

As shown in FIG. 4, the vehicle 12 according to the present embodiment is configured to include the in-vehicle instrument 20, a plurality of electronic control units (ECU’s) 22, and a plurality of in-vehicle machines 24.

The in-vehicle instrument 20 is configured to include a central processing unit (CPU) 20A, a read-only memory (ROM) 20B, a random access memory (RAM) 20C, a vehicle interior communication interface (I/F) 20D, and a wireless communication I/F 20E. The CPU 20A, the ROM 20B, the RAM 20C, the vehicle interior communication I/F 20D, and the wireless communication I/F 20E are connected to one another in a communicable manner via an internal bus 20G.

The CPU 20A is a central processing unit, executes various programs, and controls various units. That is, the CPU 20A reads out the programs from the ROM 20B, and executes the programs using the RAM 20C as a work area.

The ROM 20B stores various programs and various pieces of data. A control program 50 for collecting pieces of vehicle data on the state and control of the vehicle 12 from the ECU’s 22 and permitting or restricting the use of functions of the vehicle 12 or the application of equipment in the vehicle 12 is stored in the ROM 20B of the present embodiment. Besides, history information 110 that is a piece of backup data for the pieces of vehicle data is stored in the ROM 20B. Incidentally, the pieces of vehicle data are sampled at intervals of about 100 to 200 ms. The RAM 20C serves as a work area for temporarily storing the programs or data.

The vehicle interior communication I/F 20D is an interface to be connected to each of the ECU’s 22. The interface uses a communication standard based on a CAN protocol. The vehicle interior communication I/F 20D is connected to an external bus 20H.

The wireless communication I/F 20E is a wireless communication module for establishing communication with the server 30. This wireless communication module uses a communication standard, for example, 5G, LTE, or Wi-Fi (®). The wireless communication I/F 20E is connected to the network N.

The ECU’s 22 include at least an advanced driver assistance system (ADAS)-ECU 22A, a steering ECU 22B, a brake ECU 22C, and an engine ECU 22D.

The ADAS-ECU 22A comprehensively controls an advanced driving assistance system. A vehicle speed sensor 24A, a yaw rate sensor 24B, wheel speed sensors 24C, and a load sensor 26 constitute the in-vehicle machines 24, and are connected to the ADAS-ECU 22A. The vehicle speed sensor 24A detects a vehicle speed of the vehicle 12 and an acceleration thereof. The wheel speed sensors 24C detect wheel speeds of wheels of the vehicle 12 respectively. The wheel speed sensors 24C detect wheel speeds of the front-right wheel FR, the front-left wheel FL, the rear-right wheel RR, and the rear-left wheel RL respectively. The load sensor 26 detects a load applied to a vehicle body of the vehicle 12. The ADAS-ECU 22A may further include a camera for photographing the periphery of the vehicle 12, a sensor for searching the periphery of the vehicle 12, and the like.

The steering ECU 22B controls a power steering. A steering angle sensor 24D that constitutes one of the in-vehicle machines 24 is connected to the steering ECU 22B. The steering angle sensor 24D is a sensor that detects a steering angle of a steering wheel.

The brake ECU 22C controls a brake system of the vehicle 12. A brake actuator 24E that constitutes one of the in-vehicle machines 24 is connected to the brake ECU 22C.

The engine ECU 22D controls an engine of the vehicle 12. A throttle actuator 24F and a sensor group 24G that constitute some of the in-vehicle machines 24 are connected to the engine ECU 22D. The sensor group 24G includes an oil temperature sensor for measuring an oil temperature of engine oil, an oil pressure sensor for measuring an oil pressure of engine oil, and a rotation sensor that senses a rotational speed of the engine.

The information system ECU 22E controls a car navigation system, an audio instrument, and the like. A GPS device 29 that constitutes one of the in-vehicle machines 24 is connected to the information system ECU 22E. The GPS device 29 is a device that measures a current position of the vehicle 12. The GPS device 29 includes an antenna (not shown) that receives a signal from a GPS satellite. Incidentally, the GPS device 29 may be directly connected to the in-vehicle instrument 20.

### Server

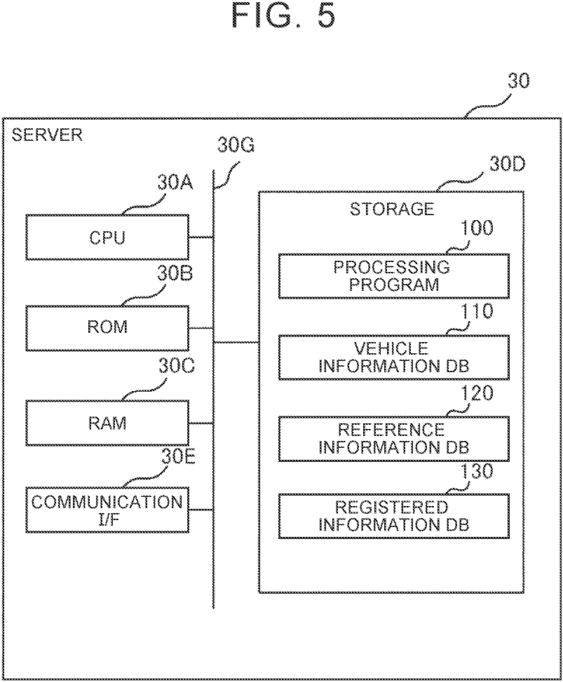

As shown in FIG. 5, the server 30 is configured to include a CPU 30A, a ROM 30B, a RAM 30C, a storage 30D, and a communication I/F 30E. The CPU 30A, the ROM 30B, the RAM 30C, the storage 30D, and the communication I/F 30E are connected to one another in a communicable manner via an internal bus 30G. The functions of the CPU 30A, the ROM 30B, the RAM 30C, and the communication I/F 30E are identical to those of the CPU 20A, the ROM 20B, the RAM 20C, and the wireless communication I/F 20E of the in-vehicle instrument 20 respectively. Incidentally, the communication I/F 30E may establish wired communication.

The storage 30D as a memory is configured by a hard disk drive (HDD) or a solid state drive (SSD), and stores various programs and various pieces of data. A processing program 100, a vehicle information database (DB) 110, a reference information DB 120, and a registered information DB 130 are stored in the storage 30D of the present embodiment. Incidentally, the ROM 30B may store the processing program 100, the vehicle information DB 110, the reference information DB 120, and the registered information DB 130.

The processing program 100 as a sensing program is a program for controlling the server 30. The server 30 performs a sensing process as the processing program 100 is executed.

Pieces of vehicle data per unit time that are collected from the vehicle 12 are stored in the vehicle information DB 110. The pieces of vehicle data include pieces of information on a vehicle speed, accelerations (a longitudinal acceleration and a lateral acceleration), a yaw rate, wheel speeds of the respective wheels, a steering angle, a load, an accelerator depression amount, a depression force applied to a brake pedal or a stroke of the brake pedal, and the like.

Data ranges determined in advance, and thresholds serving as criteria used in making various determinations of the sensing process are stored in the reference information DB 120. In the sensing process of the server 30, the pieces of vehicle data are divided and assigned to the data ranges respectively in a pre-processing unit 200 that will be described later, and the sensing is carried out through the use of differences in wheel speed for the data ranges to which the pieces of vehicle data are divided and assigned, respectively. The criteria will be described later in the description of the determinations. Each of the data ranges is a range expressed, for each of a plurality of vehicle speed zones, as a set of a plurality of time units associated with each of the vehicle speed zones. The pieces of vehicle data are acquired for the data ranges respectively. The vehicle speed zones are vehicle speed ranges. For example, vehicle speed ranges ranging from 40 km/h to 50 km/h, from 50 km/h to 60 km/h, and from 60 km/h to 70 km/h, etc. are determined as the vehicle speed zones respectively. The time units are determined as ranges defined in the unit of, for example, 10 seconds, 30 seconds, one minute, five minutes, and 10 minutes. For instance, the pieces of vehicle data acquired during 60 seconds are divided into six sets of vehicle data each corresponding to the time unit of 10 seconds. That is, the pieces of vehicle data are divided such that each of the pieces of vehicle data belongs to a data range in a certain vehicle speed zone during a certain time unit. In the case where the vehicle speed zone ranges from 40 km/h to 50 km/h and the time unit is 10 seconds, the data ranges are (0-10_{S1}, 10-20_{S2}, 20-30_{S3}, ...), which are arranged at intervals of 10 seconds. Incidentally, the pieces of vehicle data may be divided and assigned to a plurality of different time units respectively within the same vehicle speed zone. Besides, data ranges during a plurality of lengths of unit time may be set within the same vehicle speed zone. For example, it is possible to set time units of 10 seconds and 30 seconds in the vehicle speed zone ranging from 40 km/h to 50 km/h, and divide and assign the pieces of vehicle data to the data ranges respectively. By thus dividing and assigning the pieces of vehicle data to different time units respectively and conducting a fine analysis even within the same vehicle speed zone, the sensing accuracy can be enhanced. Incidentally, the vehicle speed zone to be set and the time units to be set may be decided as appropriate. Besides, the setting of the data ranges may be decided in accordance with the driving situation or the like.

Registered values corresponding to Y-intercepts registered for the data ranges respectively in the sensing process are stored in the registered information DB 130. The registered values are pieces of vehicle data plotted at coordinate positions corresponding to the Y-intercepts on the graph in a process of a calculation unit 202 that will be described later. The registered values are registered as to relative differences between target wheels respectively. Incidentally, differences in wheel speed are used to sense a fall in air pressure. Therefore, the differences in wheel speed obtained from the pieces of vehicle data may be registered instead of the pieces of vehicle data. The target wheels are the front-right wheel FR and the rear-right wheel RR as first wheels, the front-left wheel FL and the rear-left wheel RL as second wheels, the front-right wheel FR and the front-left wheel FL as third wheels, and the rear-right wheel RR and the rear-left wheel RL as fourth wheels. The difference in wheel speed between the first wheels, the difference in wheel speed between the second wheels, the difference in wheel speed between the third wheels, and the difference in wheel speed between the fourth wheels are expressed as [FR-RR], [FL-RL], [FR-FL], and [RR-RL] respectively. Besides, in the present embodiment, the registered values are repeatedly registered and hence accumulated. In repeating this registration, a registered value registered immediately prior to a most recently registered value is treated as a last value. Besides, when the vehicle 12 starts running or when the replenishment with air is reset etc., an initial value is registered in advance. Incidentally, each of the registered values is an example of the first value in the art of the present disclosure, and the last value is an example of the second value in the art of the present disclosure.

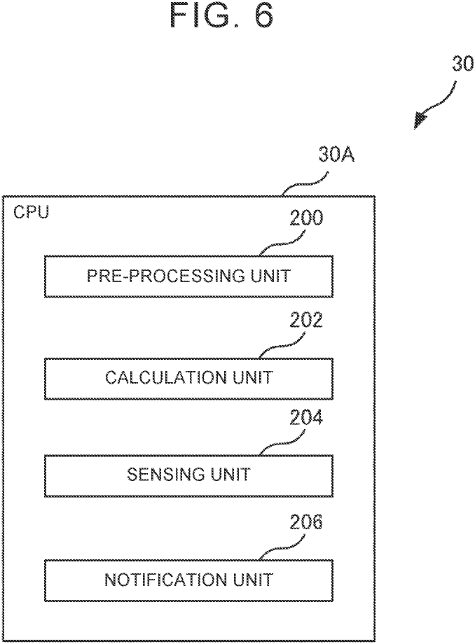

As shown in FIG. 6, the server 30 of the present embodiment functions as the pre-processing unit 200, the calculation unit 202, a sensing unit 204, and a notification unit 206 through execution of the processing program 100 by the CPU 30A.

The pre-processing unit 200 performs pre-processing as to the pieces of vehicle data. The pre-processing unit 200 acquires the pieces of vehicle data from the vehicle information DB 110, and divides and assigns the pieces of vehicle data to the data ranges in the reference information DB 120 respectively, as the pre-processing. Besides, the pre-processing unit 200 calculates differences in wheel speed between the target wheels for the data ranges respectively. That is, the pre-processing unit 200 obtains the difference [FR-RR] in wheel speed between the first wheels, the difference [FL-RL] in wheel speed between the second wheels, the difference [FR-FL] in wheel speed between the third wheels, and the difference [RR-RL] in wheel speed between the fourth wheels for each of the data ranges. The calculation unit 202 uses these differences as relative differences.

The following processes of the calculation unit 202 and the sensing unit 204 are performed for each of the data ranges to which the pieces of vehicle data divided and assigned, by the pre-processing unit 200.

The calculation unit 202 calculates linear interpolation through the use of coordinate information on a plurality of pieces of vehicle data representing a longitudinal acceleration or a steering angle with respect to the relative differences in wheel speed between the target wheels of the vehicle 12, as to the pieces of vehicle data in the data ranges respectively. The coordinate information on the pieces of vehicle data represents coordinates (an X-coordinate and a Y-coordinate) in the case where the pieces of vehicle data are plotted with the axis of ordinate in the Y-axis direction representing the relative differences in wheel speed included in the pieces of vehicle data, and with the axis of abscissa in the X-axis direction representing the longitudinal acceleration or steering angle included in the pieces of vehicle data, on the graph. That is, the coordinate information in the case where each of the pieces of sampled vehicle data is plotted on the graph in accordance with the calculated relative differences in wheel speed and the type of the data is assumed. Incidentally, for the sake of convenience of explanation, the following description may assume that the pieces of vehicle data are plotted on the graph. However, the processing is acceptable even without plotting, as long as the linear interpolation can be calculated by allocating coordinate information to the pieces of vehicle data. Besides, the pieces of vehicle data may be plotted with the data item on the X-axis representing the lateral acceleration instead of the steering angle.

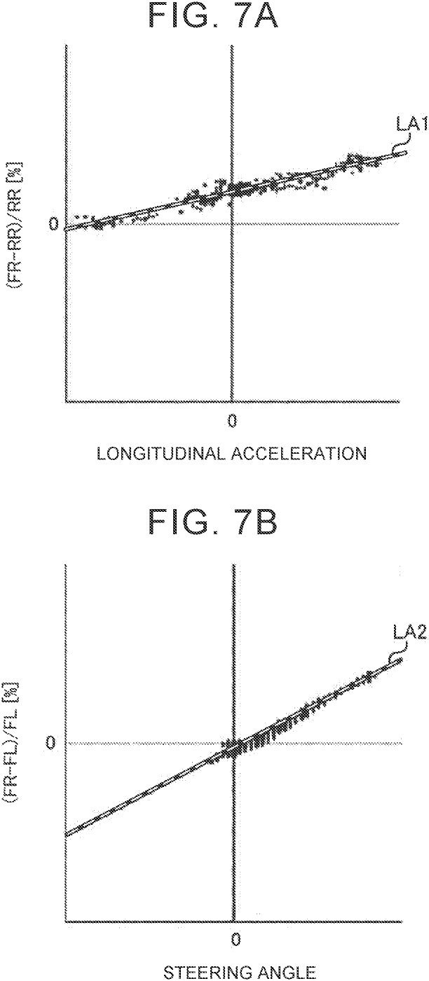

The calculation unit 202 calculates linear interpolation through the use of coordinate information on the pieces of vehicle data representing the longitudinal acceleration with respect to the relative differences in wheel speed between the front and rear wheels. That is, the coordinate information on the pieces of vehicle data representing the longitudinal acceleration with respect to each of the relative difference [FR-RR/RR] between the front-right wheel FR and the rear-right wheel RR as the first wheels and the relative difference [FL-RL/RL] between the front-left wheel FL and the rear-left wheel RL as the second wheels is used. Besides, the calculation unit 202 calculates linear interpolation through the use of coordinate information on the pieces of vehicle data representing the steering angle with respect to the relative differences between the right and left wheels. That is, the coordinate information on the pieces of vehicle data representing the steering angle with respect to each of the relative difference [FR-FL/FL] between the front-right wheel FR and the front-left wheel FL as the third wheels and the relative difference [RR-RL/RL] between the rear-right wheel RR and the rear-left wheel RL as the fourth wheels is used. FIGS. 7A and 7B are views showing an example of a graph on which pieces of vehicle data representing the longitudinal acceleration are plotted, and an example of a graph on which pieces of vehicle data representing the steering angle are plotted, respectively. FIG. 7Ais an example of a graph on which pieces of vehicle data representing the longitudinal acceleration with respect to the relative difference between the first wheels are plotted to calculate linear interpolation (LA1), and FIG. 7B is an example of a graph on which pieces of vehicle data representing the steering angle with respect to the relative difference between the third wheels are plotted to calculate linear interpolation (LA2). Besides, the calculation unit 202 obtains a decision coefficient R² for four lines for linear interpolation, and determines whether or not the decision coefficient R² is equal to or larger than a threshold α (R² ≥ α). When the decision coefficient R² is equal to or larger than the threshold α, the calculation unit 202 registers pieces of vehicle data corresponding to a Y-intercept as a registered value. The Y-intercept is a coordinate that assumes 0 on the X-axis of the graph, and the pieces of vehicle data corresponding to the Y-intercept are pieces of vehicle data plotted on the coordinate of the Y-intercept. The pieces of vehicle data are acquired as to the relative difference [FR-RR/RR] between the first wheels, the relative difference [FL-RL/RL] between the second wheels, the relative difference [FR-FL/FL] between the third wheels, and the relative difference [RR-RL/RL] between the fourth wheels respectively, and four sets of pieces of vehicle data corresponding to the four Y-intercepts respectively are registered. Incidentally, the pieces of vehicle data located at coordinates within a certain width in the X-axis direction that are close the coordinates of the Y-intercepts respectively may be registered. Besides, linear interpolation may be calculated as to only one of the longitudinal acceleration and the steering angle to be registered as pieces of vehicle data on the Y-intercept of the other. In this case, only the relationship between the differences in wheel speed between the front and rear wheels or only the relationship between the differences in wheel speed between the right and left wheels is used in the following process of the sensing unit 204.

The sensing unit 204 senses a fall in air pressure in a tire based on the differences in wheel speed between the target wheels corresponding to the registered value and the last value respectively, for the data ranges respectively. In order to check whether or not the difference in wheel speed corresponding to the registered value has smaller than the difference in wheel speed corresponding to the last value, the sensing unit 204 determines whether or not the difference in wheel speed about only a specific one of the wheels has been resolved with a value equal to or larger than the threshold, from a relationship between changes in the value obtained by subtracting the difference in wheel speed corresponding to the registered value from the difference in wheel speed corresponding to the last value. It is assumed herein that the air pressure in a specific one of the wheels has fallen as to the difference in wheel speed corresponding to the last value. In the case where some sort of replenishment with air is assumed to have been carried out, the difference in wheel speed corresponding to the registered value decreases, and hence the value obtained by subtracting (the difference in wheel speed corresponding to the registered value) from (the difference in wheel speed corresponding to the last value) increases. The last value and the registered value are compared with each other, and when the difference in wheel speed about only the specific one of the wheels becomes equal to or larger than the threshold, it can be determined that the fall in air pressure has been resolved. When the difference in wheel speed about only the specific one of the wheels is not equal to or larger than the threshold, a fall in air pressure is checked through the use of the difference in wheel speed corresponding to the registered value. In this case, the fall in air pressure has not been resolved and hence needs to be checked. On the other hand, when the difference in wheel speed about only the specific one of the wheels is equal to or larger than the threshold, it is determined that an additional air pressure has been ensured in the wheel through the repair of a flat tire, the replenishment with air or the like, and that the fall in air pressure has been resolved. When it is determined that the fall in air pressure has been resolved, the sensing unit 204 newly registers the registered value at that time as an initial value. Besides, after newly registering the initial value, the sensing unit 204 may delete and reset the history of registration of the registered value.

A method of checking a fall in air pressure will be described. As the method of checking a fall in pressure, it is possible to mention, for example, (A) a method of comparing a change in the difference in wheel speed corresponding to the registered value and a change in the difference in wheel speed corresponding to the initial value with each other, and (B) a method of comparing changes in the difference in wheel speed corresponding to the registered value itself with each other. In these methods, the air pressures in two or more wheels out of the four wheels seldom fall at the same time due to a blowout or the like, so a fall in air pressure in a specific one of the wheels is checked.

The method (A) will be described. In the case of the initial value, the wheel speed of each of the wheels has hardly changed. Therefore, when the difference in wheel speed corresponding to the initial value and the difference in wheel speed corresponding to the registered value are compared with each other, the specific wheel with a great change in wheel speed can be identified. First of all, the sensing unit 204 compares the differences in wheel speed between the target wheels corresponding to the registered value and the differences in wheel speed between the target wheels corresponding to the initial value respectively, and identifies the wheels with a great change in the difference in wheel speed. As described above in the example of FIG. 1B, the wheel with a great change in wheel speed is identified from the relationship between changes in the differences in wheel speed between the wheels. For example, when only both the difference [FR-RR] in wheel speed between the first wheels and the difference [FR-FL] in wheel speed between the third wheels have changed greatly while the differences in wheel speed between the other wheels have not changed greatly, it is possible to determine that the wheel speed of the front-right wheel FR has become high. In this manner, the sensing unit 204 identifies the wheels with the difference in wheel speed equal to or larger than the threshold, from the relationship between the change in the difference in wheel speed corresponding to the registered value and the change in the difference in wheel speed corresponding to the initial value, and thereby determines whether or not only the wheel speed of a specific one of the wheels has become high. As described above, according to the method (A), the specific wheel with a high wheel speed is sensed. In this case, when the same specific one of the wheels is sensed, for example, twice in succession, it is determined that the air pressure in the tire thereof has fallen. Erroneous sensing resulting from external factors or the like is avoided by setting successive sensing as a required condition.

Next, the method (B) will be described. When the difference in wheel speed is not large only as to one of the wheels as a result of a comparison between the registered value and the initial value, the differences in wheel speed between the target wheels corresponding to the registered value are compared with one another. That is, the sensing unit 204 compares the differences in wheel speed between the first, second, third, and fourth wheels corresponding to the registered value with one another, and determines whether or not the difference in wheel speed is equal to or larger than the threshold between any of the first, second, third, and fourth wheels, and whether or not the wheel speed of only a specific one of the wheels is high. In this manner, the sensing unit 204 identifies the wheels between which the difference in wheel speed is equal to or larger than the threshold, from the relationship between changes in the differences in wheel speed between the wheels corresponding to the most recent registered value, and thereby determines whether or not only the wheel speed of a specific one of the wheels is high. Thus, the sensing unit 204 senses the specific wheel with a high wheel speed. As described above, according to the method (B), the specific one of the wheels with a significantly high wheel speed can be sensed from the relationship between changes in the differences in wheel speed between the target wheels. Besides, in the method (B) as well, when the same wheel is sensed twice in succession, it is determined that the air pressure in the tire thereof has fallen. As described above as to the methods (A) and (B), the sensing unit 204 senses a fall in air pressure in the tire of a specific one of the wheels. Incidentally, instead of exclusively using the registered value, the specific one of the wheels may be sensed based on how the relationship between changes in wheel speed changes, through the use of the most recent registered value registered in a time-series manner.

When a fall in air pressure in the tire is sensed, the notification unit 206 notifies the vehicle 12 of a warning about the fall in air pressure.

### Flow of Control

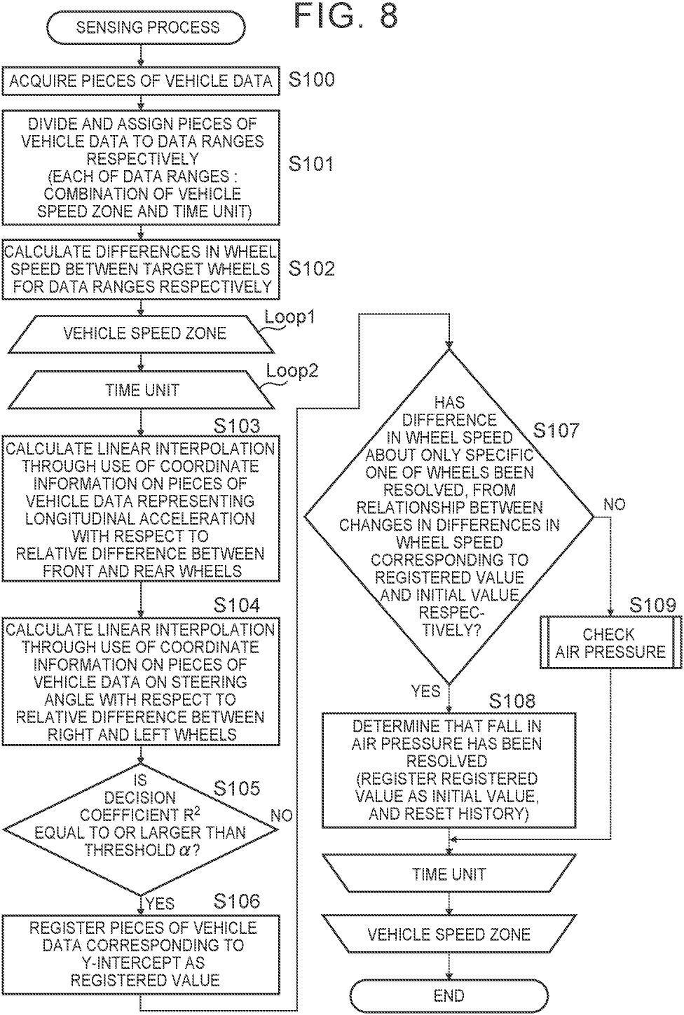

The flow of a process as a sensing method carried out in the sensing system 10 of the present embodiment will be described using a flowchart of FIG. 8. The sensing process in the server 30 is performed through the CPU 30A functioning as the respective units of the server 30. The sensing process is periodically performed at intervals of a certain time (e.g., 10 minutes) during which pieces of vehicle data are acquired from the vehicle 12. Besides, in the case where there are a plurality of vehicles 12, the sensing process is performed for each of the vehicles 12.

In step S100 of FIG. 8, the CPU 30A acquires pieces of vehicle data from the vehicle information DB 110 as pre-processing.

In step S101, the CPU 30A divides and assigns the pieces of vehicle data to a plurality of data ranges in the reference information DB 120 respectively, as pre-processing. Each of the data ranges is a combination of the vehicle speed zone and the time unit.

In step S102, the CPU 30A calculates differences in wheel speed between the target wheels for the data ranges respectively, as pre-processing.

It should be noted herein that the data ranges are Loop1 and Loop2 in the sensing process, and that the process is looped in terms of the units indicated in Loop1 and Loop2. Loop1 is a loop based on each of the vehicle speed zones, and Loop2 is a loop based on each of the time units. In Loop1, the vehicle speed zone to be processed is selected. The vehicle speed zone to be processed is selected and the process is repeated until all the vehicle speed zones are selected to end the process in Loop 1. In Loop1, Loop2 is carried out as an internal loop. In Loop2, the time unit to be processed is selected, and the processing of step S103 to S109 is performed as to the selected time unit. When the processing is ended as to all the time units in Loop2, the vehicle speed zone to be processed subsequently is selected in Loop1 and the processing is repeated. Thus, the processing of step S103 to S109 is performed for each of the data ranges.

In step S103, the CPU 30A calculates linear interpolation through the use of coordinate information on a plurality of pieces of vehicle data representing the longitudinal acceleration with respect to the relative differences between the front and rear wheels. In this case, the CPU 30A calculates linear interpolation through the use of coordinate information on a plurality of pieces of vehicle data representing the longitudinal acceleration with respect to each of the relative difference [FR-RR/RR] between the front-right wheel FR and the rear-right wheel RR as the first wheels and the relative difference [FL-RL/RL] between the front-left wheel FL and the rear-left wheel RL as the second wheels.

In step S104, the CPU 30A calculates linear interpolation through the use of coordinate information on a plurality of pieces of vehicle data representing the steering angle with respect to the relative differences between the right and left wheels. In this case, the CPU 30A calculates linear interpolation through the use of coordinate information on a plurality of pieces of vehicle data representing the steering angle with respect to each of the relative difference [FR-FL/FL] between the front-right wheel FR and the front-left wheel FL as the third wheels and the relative difference [RR-RL/RL] between the rear-right wheel RR and the rear-left wheel RL as the fourth wheels.

In step S105, the CPU 30A obtains the decision coefficient R² for four lines for linear interpolation, namely, the two lines for linear interpolation calculated in step S103 and the two lines for linear interpolation calculated in step S104, and determines whether or not the decision coefficient R² is equal to or larger than the threshold α (R² ≥ α). If the decision coefficient R² is equal to or larger than the threshold α, the CPU 30A makes a transition to step S106. If the decision coefficient R² is not equal to or larger than the threshold α, the CPU 30A ends the processing of the time unit to be processed in Loop2, and selects the next time unit.

In step S106, the CPU 30A registers the pieces of vehicle data corresponding to the Y-intercept as a registered value. The pieces of vehicle data corresponding to the Y-intercept are plotted on the coordinates of the Y-intercept. In this case, the CPU 30A acquires the pieces of vehicle data as to the relative difference [FR-RR/RR] between the first wheels, the relative difference [FL-RL/RL] between the second wheels, the relative difference [FR-FL/FL] between the third wheels, and the relative difference [RR-RL/RL] between the fourth wheels respectively, and registers the pieces of vehicle data corresponding to the four Y-intercepts respectively.

In step S107, the CPU 30A determines whether or not the difference in wheel speed corresponding to the registered value has smaller than the difference in wheel speed corresponding to the last value. That is, the CPU 30A determines whether or not the difference in wheel speed about only a specific one of the wheels has been resolved with a value equal to or larger than the threshold, from a relationship between changes in values obtained by subtracting the difference in wheel speed corresponding to the registered value from the difference in wheel speed corresponding to the last value. If it is determined that the difference in wheel speed is equal to or larger than the threshold (i.e., the difference in wheel speed has become small) (Y), the CPU 30A makes a transition to step S108. If it is determined that the difference in wheel speed is not equal to or larger than the threshold (i.e., the difference in wheel speed has not become small) (N), the CPU 30A makes a transition to step S109. Incidentally, with a view to avoiding erroneous sensing, the CPU 30A may make a transition to step S108 when it is determined that the difference in wheel speed has become small in succession.

In step S108, the CPU 30A determines that the fall in air pressure has been resolved, and newly registers the registered value registered in step S106 as an initial value. Besides, after newly registering the initial value, the CPU 30A deletes and resets the history of registration of the registered value.

In step S109, the CPU 30A checks a fall in air pressure. The details of a check process will be described later. In step S108 or upon the end of the process, the CPU 30A ends the processing of the time unit selected in Loop2, selects the next time unit, and repeats the processing.

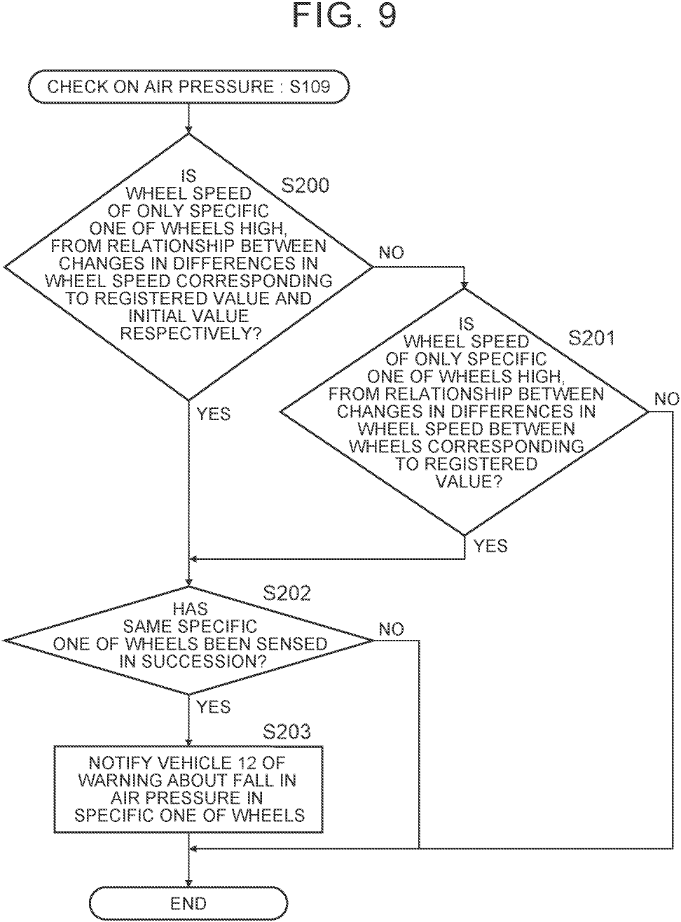

Next, the check process of step S109 will be described through the use of a flowchart of FIG. 9.

In step S200, the CPU 30A determines whether or not only the wheel speed of a specific one of the wheels has become high from the relationship between changes in the differences in wheel speed corresponding to the registered value and the initial value. The method described above in (A) is adopted as the method of determination. If it is determined that the wheel speed has become high (Y), the CPU 30A makes a transition to step S202. If it is determined that the wheel speed has not become high (N), the CPU 30A makes a transition to step S201.

In step S201, the CPU 30A determines whether or not only the wheel speed of a specific one of the wheels has become high, from the relationship between changes in the differences in wheel speed between the wheels corresponding to the registered value. The method described above in (B) is adopted as the method of determination. If it is determined that the wheel speed has become high (Y), the CPU 30A makes a transition to step S202. If it is determined that the wheel speed has not become high (N), the CPU 30A ends the process. If it is determined above in step S200 or step S201 that only the wheel speed of a specific one of the wheels has become high, the CPU 30A senses this wheel as the specific wheel.

In step S202, the CPU 30A determines whether or not the same specific one of the wheels has been sensed in succession. If it is determined that the same specific wheel has been sensed in succession (Y), the CPU 30A makes a transition to step S203. If it is determined that the same specific wheel has not been sensed in succession (N), the CPU 30A ends the process.

In step S203, the CPU 30A determines that the air pressure in the tire of the specific wheel has fallen, and notifies the vehicle 12 of a warning about a fall in air pressure in the specific wheel. Incidentally, it is not indispensable to notify the vehicle 12 of the warning as in the present step. It is also appropriate to carry out sensing as to the data ranges respectively and then notify the vehicle 12 of warnings at the same time. Alternatively, it is also appropriate to notify the vehicle 12 of a warning when a fall in air pressure is sensed in a certain number or more of data ranges.

Incidentally, the case where the determination in step S201 is made after (N) in the determination in step S200 has been described, but the disclosure is not limited thereto. Step S200 and step S201 may be permutated, or only one of the determinations in step S200 and step S201 may be made.

### Summary

The server 30 as the sensing device of the present embodiment calculates linear interpolation through the use of coordinate information in the case where the pieces of vehicle data representing the longitudinal acceleration or the steering angle with respect to the relative differences in wheel speed between the target wheels of the vehicle 12 are plotted on the graph, and registers the pieces of vehicle data corresponding to the Y-intercept. The server 30 senses a fall in air pressure in the tire based on the differences in wheel speed between the target wheels corresponding to the registered value and the last value respectively. In this manner, the pieces of vehicle data obtained from the Y-intercept can be regarded as vehicle data in a running scene where the vehicle 12 runs relatively stably. That is, a fall in air pressure in the tire can be sensed in various running scenes.

### Modification Examples

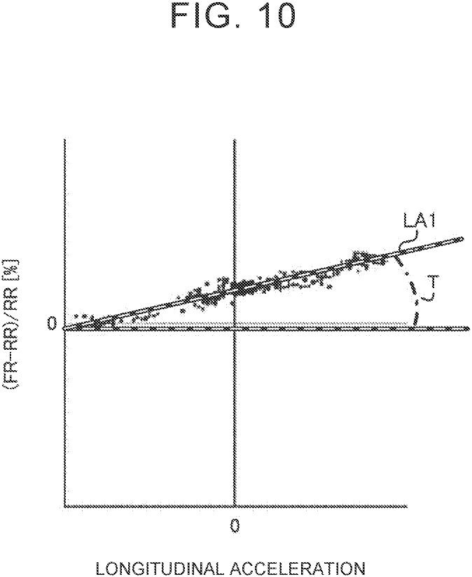

In the foregoing embodiment, the example in which a fall in air pressure in the tire of a specific one of the wheels is sensed has been described. However, the disclosure is also applicable to a case where falls in air pressure in all the tires of the four wheels of the vehicle 12 are sensed. In the case where the air pressures gradually fall simultaneously over a long period of time instead of a blowout of the tire, the four wheels may be depressurized at the same time. In this case, it is possible to sense a depressurized state through the use of a gradient T of the line for linear interpolation as shown in FIG. 10. It has been turned out that the gradient of the line for linear interpolation increases as the air pressure in the tire rises. In consequence, although the gradient of the line for linear interpolation changes even when the tire is worn out, the changes in gradient resulting from wear are gentler than the changes in gradient resulting from a reduced state of the air pressure.

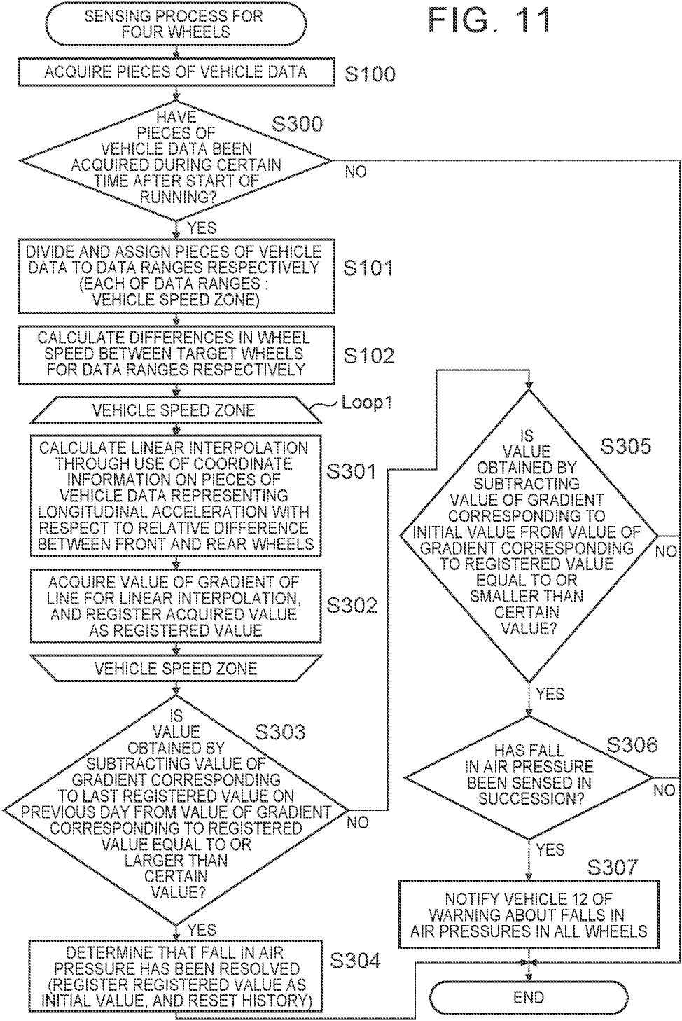

The process of sensing four wheels will be described with reference to a flowchart of FIG. 11. Incidentally, with a view to eliminating the influence of a rise in temperature of the tires during the running of the vehicle 12 or the like, only the pieces of vehicle data during a certain period of time, for example, 10 minutes after the start of the running of the vehicle 12 may be used. Since the use of the pieces of vehicle data is limited to the certain period of time, the data ranges concern the vehicle speed zone only, with the loop of time unit removed. The process of sensing the four wheels is periodically performed at intervals of a certain time during which the pieces of vehicle data are acquired from the vehicle 12.

In step S300, the CPU 30A determines whether or not the pieces of vehicle data have been acquired within the certain time after the start of the running of the vehicle 12. If it is determined that the pieces of vehicle data have been acquired within the certain time, the CPU 30A makes a transition to step S101. If it is determined that the pieces of vehicle data have not been acquired within the certain time, the CPU 30A ends the process.

After step S101 and step S102, the CPU 30A carries out step S301 and step S302 for each of the vehicle speed zones through Loop1.

In step S301, the CPU 30A calculates linear interpolation through the use of coordinate information on the pieces of vehicle data representing the longitudinal acceleration with respect to the relative differences between the front and rear wheels. In this case, only the longitudinal acceleration is used.

In step S302, the CPU 30A acquires a value of the gradient of the line for linear interpolation, and registers the acquired value as a registered value.

In step S303, the CPU 30A determines whether or not a value obtained by subtracting the value of the gradient of a last registered value on the previous day from the value of the gradient corresponding to the registered value is equal to or larger than a certain value. If it is determined that the value obtained through subtraction is equal to or larger than the certain value (Y), the CPU 30A makes a transition to step S304. If it is determined that the value obtained through subtraction is not equal to or larger than the certain value (N), the CPU 30A makes a transition to step S305.

In step S304, the CPU 30A determines that the fall in air pressure has been resolved, and newly registers the registered value registered in step S302 as the initial value. Incidentally, in the process of sensing the four wheels, the registered value registered first is registered as the initial value.

In step S305, the CPU 30A determines whether or not a value obtained by subtracting the value of the gradient corresponding to the initial value from the value of the gradient corresponding to the registered value is equal to or smaller than a certain value. If it is determined that the value obtained through subtraction is equal to or smaller than the certain value (Y), the CPU 30A makes a transition to step S306. If it is determined that the value obtained through subtraction is not equal to or smaller than the certain value (N), the CPU 30A ends the process.

In step S306, the CPU 30A determines whether or not a fall in air pressure has been sensed in succession. If it is determined that a fall in air pressure has been sensed in succession (Y), the CPU 30A makes a transition to step S307. If it is determined that a fall in air pressure has not been sensed in succession (N), the CPU 30A ends the process.

In step S307, the CPU 30A determines that the air pressures in the tires of the four wheels have fallen, and notifies the vehicle 12 of a warning about the falls in air pressure in all the wheels. The foregoing is the description of the sensing process for the four wheels.

Besides, in the foregoing embodiment, the example in which the sensing process is performed by the pre-processing unit 200, the calculation unit 202, and the sensing unit 204 of the server 30 has been described, but the disclosure is not limited thereto. The processes that the respective units of the server 30 are in charge of may be performed on the vehicle side. Besides, one or some of the processes in the server 30 may be performed on the vehicle 12 side. For example, the pre-processing unit 200 may divide and assign the pieces of vehicle data to the data ranges respectively, and calculate the differences in wheel speed. The processes in the calculation unit 202 and the sensing unit 204 may also be performed in the vehicle 12.

Incidentally, the various processes performed by the CPU 20A and the CPU 30A by reading software (the programs) in the foregoing embodiment may be performed by various processors other than the CPU. As the processors in this case, a programmable logic device (PLD) that can be changed in circuit configuration after being manufactured, such as a field-programmable gate array (FPGA), a dedicated electric circuit that is a processor having a circuit configuration exclusively designed to perform a specific process, such as an application specific integrated circuit (ASIC), and the like are exemplified. Besides, the foregoing respective processes may be performed by one of these various processors, or a combination of two or more identical or different processors (e.g., a plurality of FPGA’s, or a combination of a CPU and an FPGA). Besides, the hardware structure of these various processors is, more specifically, an electric circuit configured by combining circuit elements such as semiconductor elements.

Besides, the foregoing embodiment has been described on the assumption that the respective programs are stored (installed) in advance in a readable non-transitory recording medium (storage medium). For example, the program in the in-vehicle instrument 20 is stored in advance in the ROM 20B, and the processing program 100 in the server 30 is stored in advance in the storage 30D, but the disclosure is not limited thereto. The respective programs may be provided as being recorded in a non-transitory recording medium such as a compact disc read-only memory (CD-ROM), a digital versatile disc read-only memory (DVD-ROM), or a universal serial bus (USB). Besides, the programs may be downloaded from an external device via a network.

The flow of the processes described in the foregoing embodiment is an example. It is possible to delete unnecessary steps, add new steps, or permutate the processing steps within such a range as not to depart from the gist of the disclosure.

What is claimed is:

1. A sensing device comprising:
a processor, wherein
the processor handles a plurality of pieces of sampled vehicle data divided and assigned to a plurality of data ranges set in advance respectively, and calculates linear interpolation through use of coordinate information on the pieces of vehicle data representing at least one of a longitudinal acceleration, a steering angle, and a lateral acceleration with respect to a relative difference in wheel speed between predetermined wheels, that is, front and rear wheels or right and left wheels of a vehicle, for the data ranges respectively, the processor registers the pieces of vehicle data corresponding to a Y-intercept as to the relative difference in wheel speed between the predetermined wheels, based on the calculated linear interpolation, for the data ranges respectively, and the processor senses a fall in air pressure in a tire through use of the difference in wheel speed between the predetermined wheels in the registered pieces of vehicle data, for the data ranges respectively.

2. The sensing device according to claim 1, wherein
a first value is defined as the registered piece of vehicle data, and
the processor compares the difference in wheel speed between the predetermined wheels corresponding to the first value with the difference in wheel speed between the predetermined wheels corresponding to a second value registered as the first value prior to the first value, and determines whether or not the difference in wheel speed about only a specific one of the wheels has been resolved with a value equal to or larger than a threshold, from a relationship between values obtained by subtracting the difference in wheel speed corresponding to the first value from the difference in wheel speed corresponding to the second value, in the sensing,
the processor determines that the fall in air pressure has been resolved when it is determined that the difference in wheel speed has become equal to or larger than the threshold, and
the processor determines that there is a possibility of a fall in air pressure, and senses the fall in air pressure through use of the wheel speeds of the respective wheels in the piece of vehicle data corresponding to the first value, when it is determined that the difference in wheel speed has not become equal to or larger than the threshold.

3. The sensing device according to claim 2, wherein
the processor adopts the most recent first value as an initial value, and deletes a history of the first value registered previously, when it is determined that the difference in wheel speed has become equal to or larger than the threshold and it is sensed that the fall in air pressure has been resolved.

4. The sensing device according to claim 2, wherein
the processor determines that the air pressure has fallen as to the specific one of the wheels, at least either when there is a difference in wheel speed that is equal to or larger than the threshold between certain ones of the wheels and only the wheel speed of the specific one of the wheels is high as a result of a comparison between the difference in wheel speed between the predetermined wheels corresponding to the first value and the difference in wheel speed between the predetermined wheels corresponding to the initial value registered in advance, or when there is a difference in wheel speed that is equal to or larger than the threshold between certain ones of the wheels and only the wheel speed of the specific one of the wheels is high as a result of a comparison between the differences in wheel speed between the predetermined wheels corresponding to the first value, in sensing the fall in air pressure in a case where there is a possibility of the fall in air pressure.

5. The sensing device according to claim 1, wherein
each of the data ranges is a range set as to a combination of a vehicle speed zone of the vehicle and a certain time unit, and
the processor calculates the linear interpolation through use of the pieces of vehicle data divided and assigned to the data ranges respectively, registers the pieces of vehicle data, and senses the fall in air pressure, for the data ranges respectively.

6. The sensing device according to claim 1, wherein
the predetermined wheels include the front-right wheel and the rear-right wheel as first wheels and the front-left wheel and the rear-left wheel as second wheels, as to the front and rear wheels, and the front-right wheel and the front-left wheel as third wheels and the rear-right wheel and the rear-left wheel as fourth wheels as to the right and left wheels, and
the processor calculates linear interpolation through use of coordinate information on the pieces of vehicle data representing the longitudinal acceleration with respect to a relative difference in wheel speed between the first wheels and a relative difference in wheel speed between the second wheels, and calculates linear interpolation through use of coordinate information on the pieces of vehicle data representing the steering angle or the lateral acceleration with respect to a relative difference in wheel speed between the third wheels and a relative difference in wheel speed between the fourth wheels, for the data ranges respectively,
the processor registers the pieces of vehicle data on the Y-intercept as to the relative differences between the first wheels, the second wheels, the third wheels, and the fourth wheels respectively, for the data ranges respectively, and
the processor senses a fall in air pressure in a tire of a specific one of the wheels from a relationship between changes in the differences in wheel speed in the pieces of vehicle data registered as to the first wheels, the second wheels, the third wheels, and the fourth wheels, for the data ranges respectively.

7. The sensing device according to claim 1, wherein
the processor registers a value of a gradient of the linear interpolation, and
the processor senses falls in air pressure in all the wheels of the vehicle by comparing the registered value with a value of a gradient preceding the registered value.

8. A sensing system comprising:
the sensing device according to claim 1 as a server, wherein
the pieces of vehicle data are acquired in the vehicle and transmitted to the server, and the server notifies the vehicle of a warning, upon sensing a fall in air pressure in a tire of a specific one of the wheels.

9. A sensing method of causing a computer to perform a process in which
a processor handles a plurality of pieces of sampled vehicle data divided and assigned to a plurality of data ranges set in advance respectively, and calculates linear interpolation through use of coordinate information on the pieces of vehicle data representing at least one of a longitudinal acceleration, a steering angle, and a lateral acceleration with respect to a relative difference in wheel speed between predetermined ones of front and rear wheels or right and left wheels of a vehicle, for the data ranges respectively,
the processor registers the pieces of vehicle data corresponding to a Y-intercept as to the relative difference in wheel speed between the predetermined wheels, based on the calculated linear interpolation, for the data ranges respectively, and
the processor senses a fall in air pressure in a tire through use of the difference in wheel speed between the predetermined wheels in the registered pieces of vehicle data, for the data ranges respectively.

10. A non-transitory storage medium that stores a sensing program of causing a computer to perform a process in which
a processor handles a plurality of pieces of sampled vehicle data divided and assigned to a plurality of data ranges set in advance respectively, and calculates linear interpolation through use of coordinate information on the pieces of vehicle data representing at least one of a longitudinal acceleration, a steering angle, and a lateral acceleration with respect to a relative difference in wheel speed between predetermined ones of front and rear wheels or right and left wheels of a vehicle, for the data ranges respectively,
the processor registers the pieces of vehicle data corresponding to a Y-intercept as to the relative difference in wheel speed between the predetermined wheels, based on the calculated linear interpolation, for the data ranges respectively, and
the processor senses a fall in air pressure in a tire through use of the difference in wheel speed between the predetermined wheels in the registered pieces of vehicle data, for the data ranges respectively.
